(19) United States
(12) Patent Application Publication
(10) Pub. No.: US 2026/0330350 A1
(43) Pub. Date: Oct. 22, 2026

(54) AUTONOMOUS AI-DRIVEN SERVICE PROVIDER ACQUISITION, ONBOARDING, AND DISPATCH SYSTEM FOR REAL-TIME SERVICE FULFILLMENT

(71) Applicant: Loay Jamal Alyousfi, Tucson, AZ (US)

(72) Inventor: Loay Jamal Alyousfi, Tucson, AZ (US)

(21) Appl. No.: 19/693,042

(22) Filed: May 29, 2026

Related U.S. Application Data
(60) Provisional application No. 63/939,152, filed on Dec. 12, 2025.

(51) Int. Cl. G06Q 10/0631

(52) U.S. Cl. CPC G06Q 10/063114; G06Q 10/063112

(57) ABSTRACT

A computer-implemented platform for autonomous service network expansion is disclosed. A service request is evaluated against registered provider availability and threshold conditions. When supply is insufficient, the platform generates a machine-readable coverage deficiency event. In response, the platform identifies external candidate providers, ranks candidates using classification logic, applies compliance rules, transmits secure onboarding invitations, validates onboarding data, activates a provider node, and assigns the originating service request to the activated provider node. System outcomes are fed into a learning engine to modify future thresholds, rankings, search radii, invitations, compliance sequencing, and incentives. In some embodiments, the platform is applied to locksmith services using licensing verification, VIN analysis, key-type determination, and equipment-capability matching.

### CROSS-REFERENCE TO RELATED APPLICATIONS

This application claims the benefit of U.S. Provisional Patent Application No. 63/939,152, filed Dec. 12, 2025, titled AUTONOMOUS AI-DRIVEN SERVICE PROVIDER ACQUISITION, ONBOARDING, AND DISPATCH SYSTEM FOR REAL-TIME SERVICE FULFILLMENT, the entirety of which is incorporated herein by reference.

### STATEMENT REGARDING FEDERALLY SPONSORED RESEARCH OR DEVELOPMENT

Not applicable.

### REFERENCE TO SEQUENCE LISTING, TABLE, OR COMPUTER PROGRAM LISTING

Not applicable.

### FIELD OF THE INVENTION

The present disclosure relates to distributed computer systems, artificial intelligence orchestration systems, event-driven computing architectures, autonomous dispatch systems, compliance-aware onboarding systems, and service fulfillment platforms. More particularly, the disclosure relates to systems and methods that convert real-time service demand into executable service capacity by detecting coverage deficiencies, identifying candidate providers, initiating onboarding, performing qualification and compliance verification, activating a provider node, and assigning a service request to the activated provider node through a closed-loop computer-implemented workflow.

### BACKGROUND OF THE INVENTION

Conventional service marketplaces and dispatch systems are generally built around pre-existing provider networks. Providers typically register before user demand occurs, and the platform thereafter attempts to match incoming user requests to the providers already present within the platform.

This model creates a structural failure point. When a service request is received in a geographic area lacking a sufficient number of qualified, available, or responsive providers, the platform cannot fulfill the request without manual intervention or without delaying the user while human operators attempt to recruit or contact additional providers.

Existing platforms may expand coverage by using advertising campaigns, manual outbound calls, directories, referral programs, or human dispatchers. These approaches are slow, expensive, and not tightly coupled to the specific service request that created the need for additional capacity.

Existing systems also lack a machine-readable event architecture that treats an unmet service request as a trigger for autonomous creation of additional provider supply. Instead, conventional systems assume that supply must already exist in the platform before demand can be fulfilled.

Additional limitations arise in regulated or trust-sensitive service industries. In locksmith services, roadside assistance, emergency facility access, commercial maintenance, medical equipment servicing, and similar fields, a platform must evaluate identity, credentials, location, capability, insurance, equipment, licensing, and compliance requirements before a provider may be dispatched. Manual provider qualification can create unacceptable delays, particularly when the user request is urgent.

There is therefore a need for a computer-implemented system that detects service coverage deficiencies, generates a machine-readable coverage deficiency event, autonomously searches for qualified external providers, performs compliance-aware onboarding, activates a provider node, assigns a service request, and updates system state based on the outcome. There is further a need for such a system to operate in real time, across multiple geographic regions, and without requiring human dispatch or manual provider recruitment.

### SUMMARY OF THE INVENTION

The present invention provides systems, methods, and computer-readable media for autonomous demand-triggered service provider acquisition, onboarding, activation, and assignment. The invention may be implemented as a distributed event-driven platform in which a service request is evaluated against provider availability, service capability, compliance, and response-time conditions.

In one embodiment, a service request is received from a user device. A coverage evaluation engine determines whether a sufficient number of eligible providers exists within one or more geographic regions or search radii. When a threshold condition indicates insufficient supply, the system generates a Coverage Deficiency Event. The Coverage Deficiency Event may be published to an event bus, queue, stream, or other event processing layer.

In response to the Coverage Deficiency Event, an autonomous provider discovery engine identifies candidate service providers that are not currently registered in the platform. Candidate providers may be identified from external data sources, including public directories, business listings, professional association records, licensing databases, search results, prior invite records, vendor databases, mapping sources, or third-party APIs.

An artificial intelligence classification engine may classify and rank candidate providers based on predicted capability, proximity, likely availability, response probability, credential status, equipment capability, trust signals, price estimates, prior interactions, jurisdictional rules, service type, and historical fulfillment data.

A compliance orchestration layer may apply identity checks, credential checks, jurisdiction-specific licensing rules, insurance verification, bonding requirements, business registration checks, do-not-contact controls, communication frequency limits, sanction or exclusion rules, or other qualification criteria before an invitation is transmitted or before a provider is activated.

An invitation system may generate a secure invitation token. The invitation token may be cryptographically generated, time-limited, bound to a candidate provider identity, bound to a service request, bound to a geographic region, or bound to a compliance workflow. The invitation may be transmitted by SMS, email, in-app message, voice call, push notification, web link, messaging platform, API call, or other communication channel.

Upon provider interaction with the invitation, an onboarding subsystem collects provider information, verifies identity and credentials, confirms service capabilities, validates equipment, obtains acceptance of terms, creates a provider account, and activates a provider node within the platform.

A job assignment engine may assign the original service request to the newly activated provider node, thereby completing a closed-loop workflow in which the same demand event that revealed insufficient coverage also causes provider acquisition, onboarding, activation, and deployment.

In some embodiments, the system continuously learns from service outcomes. Completion status, response time, provider ratings, cancellation data, compliance failures, fraud signals, pricing acceptance, travel times, and regional demand patterns may be fed into a learning and adaptation engine that modifies future thresholds, rankings, routing, search radii, invitation timing, incentive amounts, and candidate selection.

In some embodiments, the invention is applied to locksmith services. The system may verify locksmith licensing, certifications, insurance, business registration, equipment, and geographic availability. The system may also analyze a vehicle identification number (VIN) or other vehicle identifier to determine key type, transponder requirements, programming capability, equipment requirements, and provider suitability before assignment.

In other embodiments, the invention may be applied to roadside assistance, towing, appliance repair, HVAC repair, field services, medical equipment servicing, emergency facility access, commercial maintenance, utility services, property access, security services, and other real-world service categories where provider availability, qualification, and rapid dispatch are material to fulfillment.

### BRIEF DESCRIPTION OF THE DRAWINGS

FIG. 1 illustrates an exemplary system architecture including a user device, service request intake engine, event bus, artificial intelligence dispatch agent, provider discovery engine, compliance engine, invitation system, onboarding subsystem, job assignment engine, provider availability database, and feedback-learning module.

FIG. 2 illustrates an exemplary coverage deficiency detection flow in which a new service request is received, provider availability is queried, eligibility is evaluated, and a Coverage Deficiency Event is generated when available supply is insufficient.

FIG. 3 illustrates exemplary artificial intelligence dispatch agent logic for processing a Coverage Deficiency Event, searching external provider sources, classifying and ranking candidate providers, applying compliance checks, and generating invitations.

FIG. 4 illustrates an exemplary provider invitation and compliance workflow including candidate qualification, do-not-contact and frequency checks, invitation token creation, communication channel selection, and transmission of an invite.

FIG. 5 illustrates exemplary conditional onboarding and assignment including provider registration, invite token validation, provider account creation, credential verification, provider activation, and automatic assignment of the originating service request.

FIG. 6 illustrates an exemplary dynamic radius expansion process for increasing search boundaries based on elapsed time, urgency, service type, predicted travel time, regional density, or probability of fulfillment.

FIG. 7 illustrates an exemplary compliance rule engine configured to apply jurisdiction-specific qualification rules, credential checks, licensing requirements, insurance requirements, and audit logging.

FIG. 8 illustrates an exemplary learning loop in which fulfillment outcomes update ranking models, threshold conditions, invitation strategies, and predictive coverage models.

FIG. 9 illustrates an exemplary locksmith-specific embodiment using VIN analysis, key-type determination, equipment-capability matching, and credential verification.

FIG. 10 illustrates an exemplary multi-region autonomous service network in which coverage deficiency events from multiple regions are processed by one or more distributed AI dispatch agents.

### DETAILED DESCRIPTION OF THE INVENTION

The following detailed description is provided to enable one of ordinary skill in the art to make and use the disclosed invention. The described embodiments are examples and are not intended to limit the scope of the claims. Features described in connection with one embodiment may be combined with features of another embodiment unless such combination is expressly incompatible.

### REFERENCE NUMERALS

| Reference No. | Element |
|---|---|
| 100 | autonomous service network platform |
| 102 | user device |
| 104 | service request |
| 106 | service request intake engine |
| 108 | provider availability database |
| 110 | coverage evaluation engine |
| 112 | Coverage Deficiency Event |
| 114 | event bus or event processing layer |
| 116 | AI dispatch agent |
| 118 | external provider sources |
| 120 | provider discovery engine |
| 122 | AI classification engine |
| 124 | candidate provider profile |
| 126 | compliance orchestration layer |
| 128 | jurisdictional rules database |
| 130 | invitation system |
| 132 | secure invitation token |
| 134 | communication gateway |
| 136 | onboarding subsystem |
| 138 | provider account |
| 140 | provider node |
| 142 | job assignment engine |
| 144 | assignment score |
| 146 | fulfillment monitoring engine |
| 148 | learning and adaptation engine |
| 150 | audit log |
| 152 | incentive engine |
| 154 | VIN analysis module |
| 156 | equipment capability database |
| 158 | multi-region coordinator |

### System Architecture

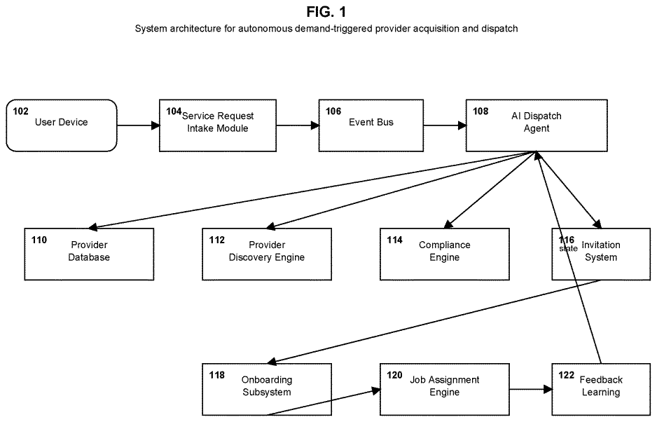

Referring to FIG. 1, an autonomous service network platform 100 may receive a service request 104 from a user device 102 through a service request intake engine 106. The service request 104 may include one or more of a location, service type, urgency level, desired service time, customer identity, asset identifier, vehicle identifier, access credential requirement, price preference, user consent data, and communication channel preference.

The provider availability database 108 stores data describing registered providers, provider nodes, provider locations, provider service categories, provider credentials, provider equipment, provider operating hours, response-time statistics, acceptance history, performance scores, jurisdictional limitations, insurance or bonding information, account status, and compliance status.

The coverage evaluation engine 110 determines whether providers listed in the provider availability database 108 are eligible to satisfy the service request 104. Eligibility may be determined using location, distance, estimated travel time, service capability, credential status, equipment availability, working hours, response time, service price, customer preference, or regulatory constraints.

The coverage evaluation engine 110 may apply one or more threshold conditions. A threshold condition may include a minimum number of eligible providers, a maximum estimated response time, a minimum predicted acceptance probability, a minimum trust score, a maximum customer wait time, a service-specific compliance requirement, a minimum equipment capability score, or any combination thereof.

When the coverage evaluation engine 110 determines that supply is insufficient, the system generates a Coverage Deficiency Event 112. The Coverage Deficiency Event 112 may be transmitted through an event bus 114 to one or more AI dispatch agents 116.

The AI dispatch agent 116 may orchestrate provider discovery, provider classification, compliance checks, invitation generation, onboarding, activation, and assignment. In some embodiments, the AI dispatch agent 116 is implemented using a rules engine. In other embodiments, the AI dispatch agent 116 includes one or more machine learning models, large language models, tool-calling agents, retrieval-augmented generation systems, reinforcement learning systems, ranking models, or hybrid deterministic and probabilistic decision systems.

### Coverage Deficiency Event

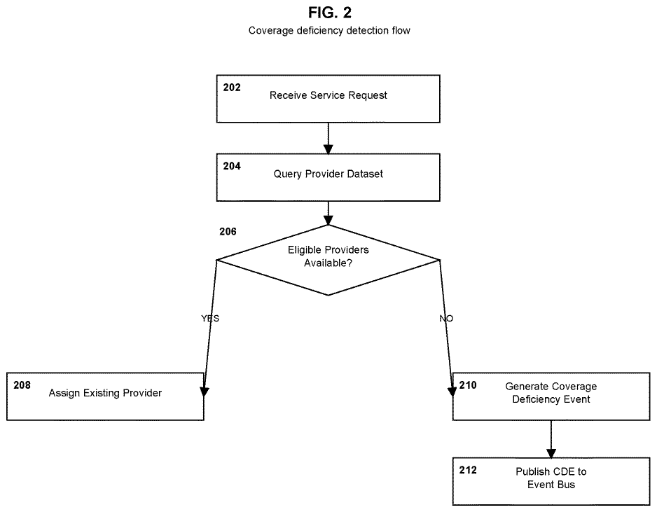

Referring to FIG. 2, the Coverage Deficiency Event 112 represents a machine-readable signal indicating unmet service demand. The Coverage Deficiency Event 112 may include a service category, geographic coordinates, geohash, postal code, region identifier, urgency level, time window, customer wait threshold, compliance requirements, required equipment, asset identifier, expected value, incentive budget, and expiration time.

The Coverage Deficiency Event 112 differs from a conventional failed match notification because it is not merely an alert to a human operator. Instead, the Coverage Deficiency Event 112 acts as an executable trigger that launches downstream autonomous provider-generation workflows.

The Coverage Deficiency Event 112 may be published to a queue, event stream, message broker, webhook endpoint, serverless function, microservice bus, or distributed workflow engine. Event publication allows independent processing modules to subscribe to and act upon unmet demand conditions in real time.

The event bus 114 may prioritize events based on urgency, customer risk, service type, revenue, regulatory requirement, safety condition, customer history, or predicted abandonment probability. In some embodiments, multiple AI dispatch agents 116 process different Coverage Deficiency Events 112 in parallel across multiple geographic regions.

### Autonomous Provider Discovery

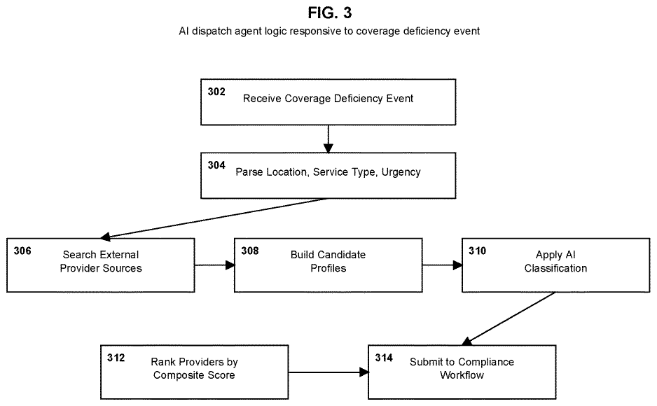

Referring to FIG. 3, the provider discovery engine 120 accesses one or more external provider sources 118 to identify candidate providers that are not currently registered as active provider nodes in the platform 100. External provider sources 118 may include business directories, search engines, map listings, professional association databases, licensing databases, public records, insurance databases, prior invite databases, customer referral databases, manufacturer service databases, dealer records, social media business pages, or third-party APIs.

The provider discovery engine 120 may generate a candidate provider profile 124 for each identified provider. The candidate provider profile 124 may include provider name, business name, phone number, email address, website, service categories, geographic service area, estimated location, operating hours, license number, public rating, equipment indicators, service descriptions, fleet indicators, and prior contact history.

Candidate provider profiles 124 may be deduplicated, normalized, enriched, and associated with confidence scores. For example, phone numbers may be normalized, addresses geocoded, service descriptions parsed, licensing identifiers matched, and candidate profiles merged when multiple external records correspond to the same provider.

The platform 100 may apply retrieval, scraping, API access, search query generation, natural language parsing, structured data extraction, entity resolution, geospatial filtering, or embedding similarity techniques to identify and enrich candidate provider profiles 124.

### Artificial Intelligence Classification and Ranking

The AI classification engine 122 ranks candidate provider profiles 124 according to one or more predicted suitability measures. Suitability may be based on capability, availability, proximity, trustworthiness, likelihood of accepting an invitation, likely response time, likely completion probability, equipment fit, jurisdictional compliance, cost estimate, prior performance, or customer outcome prediction.

The AI classification engine 122 may include a supervised model trained on historical fulfillment data, a ranking model trained on acceptance and completion outcomes, a classification model trained to identify service capability from unstructured provider descriptions, an embedding model that compares service request requirements to candidate descriptions, or a rule-based scoring system.

In some embodiments, the AI classification engine 122 calculates an assignment-readiness score before onboarding is complete. This score predicts whether a candidate provider can become a usable provider node 140 quickly enough to satisfy the service request 104. The system may avoid inviting candidates whose expected onboarding time exceeds the customer wait threshold.

The AI classification engine 122 may also identify uncertainty. When confidence is insufficient, the system may request additional information from a candidate provider, increase the search radius, escalate to a different communication channel, invite multiple providers, or fall back to predictive pre-onboarding.

### Compliance Orchestration Layer

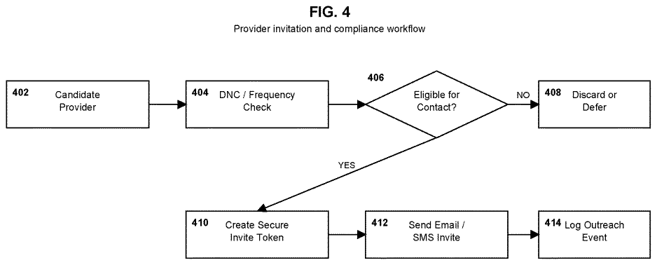

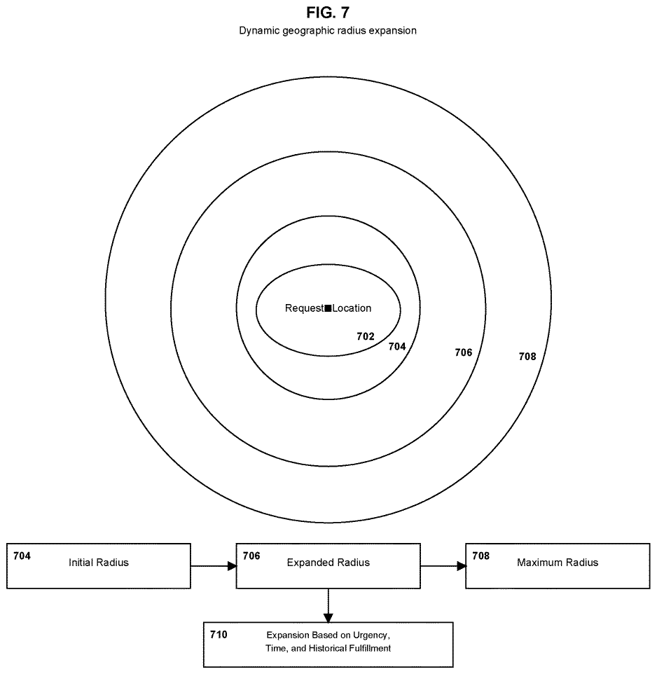

Referring to FIG. 4 and FIG. 7, the compliance orchestration layer 126 applies qualification requirements before invitation transmission, before account creation, before activation, before assignment, or before payment. Compliance rules may be obtained from a jurisdictional rules database 128.

Compliance checks may include identity verification, business registration validation, locksmith license verification, contractor license verification, insurance verification, bonding verification, sanctions screening, fraud risk scoring, background check initiation, equipment attestation, certification verification, tax-document collection, and acknowledgement of platform safety requirements.

The jurisdictional rules database 128 may map service type, location, jurisdiction, urgency, asset type, and provider category to required onboarding steps. For example, a locksmith request in one state may require a statewide license, whereas another jurisdiction may require local registration or no statewide credential. The platform 100 may adapt the onboarding workflow based on such rules.

The compliance orchestration layer 126 may also enforce communication eligibility, including do-not-contact restrictions, opt-out rules, communication frequency limits, channel preferences, consent status, and prior response history.

The compliance orchestration layer 126 may generate an audit log 150 that records data sources queried, compliance rules applied, verification outcomes, token generation, provider responses, assignment decisions, and system state updates. The audit log 150 may support dispute resolution, regulatory review, insurance requirements, fraud detection, and model-improvement processes.

### Invitation Token and Secure Onboarding

The invitation system 130 may generate a secure invitation token 132. The secure invitation token 132 may be cryptographically signed, encrypted, time-limited, single-use, rate-limited, bound to a service request, bound to a candidate provider profile, bound to a communication channel, bound to a geographic region, or bound to a compliance workflow.

The secure invitation token 132 may encode or reference a candidate provider identifier, Coverage Deficiency Event identifier, service request identifier, expiration time, required onboarding steps, incentive parameters, and fraud-prevention metadata. In some embodiments, the token stores only a reference identifier while sensitive data remains server-side.

The communication gateway 134 may transmit the invitation through SMS, email, push notification, messaging platform, automated voice call, API, web portal link, or other channel. The channel may be selected based on likelihood of response, cost, urgency, prior provider behavior, channel verification status, or regulatory communication rules.

When a candidate provider uses the token, the onboarding subsystem 136 validates the token, checks expiration, confirms identity binding, evaluates risk, and initiates an onboarding workflow tailored to the provider, service category, jurisdiction, and urgency of the originating service request 104.

### Provider Onboarding and Activation

The onboarding subsystem 136 may collect provider data, including legal name, business name, address, service categories, operating area, licenses, insurance certificates, tax information, payment details, identity documents, equipment inventory, vehicle information, background check authorization, device information, and acceptance of platform terms.

The onboarding subsystem 136 may support full onboarding, partial onboarding, conditional onboarding, emergency onboarding, staged verification, temporary activation, probationary activation, or delayed activation. For example, a provider may be permitted to accept a job after identity and credential verification but before completion of non-critical profile enrichment.

Upon satisfaction of activation criteria, the platform creates a provider account 138 and activates a provider node 140. The provider node 140 may be stored in the provider availability database 108 and made eligible for assignment to the originating service request 104 or to later service requests.

Activation criteria may differ by service category and jurisdiction. In a high-trust service category, activation may require license verification, insurance verification, identity verification, and equipment attestation. In a lower-risk category, activation may require fewer checks.

### Assignment Optimization

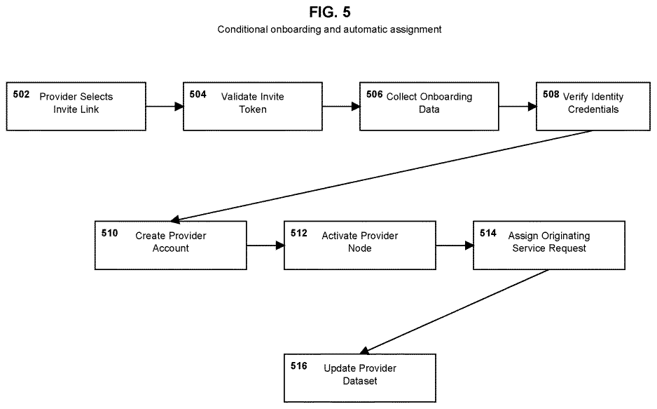

Referring to FIG. 5, the job assignment engine 142 assigns the service request 104 to an activated provider node 140. The assignment may occur automatically after onboarding, without human dispatcher intervention.

The job assignment engine 142 may calculate an assignment score 144 based on proximity, estimated travel time, readiness, credential status, equipment capability, customer rating, acceptance speed, incentive cost, pricing, user preference, jurisdictional compliance, service type, and predicted completion probability.

The platform 100 may invite a single candidate provider, invite multiple candidate providers sequentially, invite multiple candidate providers simultaneously, conduct a competitive acceptance process, or assign based on a ranked queue. The job may be assigned to the first provider satisfying eligibility rules, to the highest scoring provider, to the lowest priced eligible provider, to the fastest provider, or to a provider selected by a hybrid ranking model.

In some embodiments, the system updates the original service request 104 when a provider node 140 becomes available. The user device 102 may receive a notification identifying the provider, estimated arrival time, price, status, or compliance badge. In other embodiments, the provider accepts the service request before the user receives final confirmation.

### Closed-Loop Demand-Triggered Provider Generation

A central aspect of the invention is that the service request 104 may trigger provider discovery, provider onboarding, provider activation, and provider assignment in a single execution cycle. Thus, the platform 100 does not merely match demand to existing supply. The platform 100 converts demand into newly activated supply.

In one example, a user submits a request for a locksmith service in a region without registered providers. The coverage evaluation engine 110 generates a Coverage Deficiency Event 112. The AI dispatch agent 116 identifies external locksmiths, ranks them, applies compliance rules, sends secure invitations, onboards a responding locksmith, verifies licensing, creates a provider node 140, and assigns the original request to the newly activated provider node 140.

This closed-loop architecture reduces cold-start failures, improves geographic expansion, reduces manual recruiting, and allows the platform 100 to grow in response to actual demand signals rather than only through speculative pre-market provider acquisition.

### Feedback Learning and Self-Healing Network

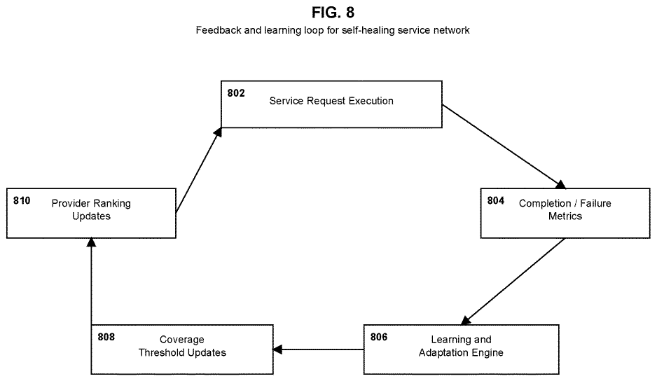

Referring to FIG. 8, the fulfillment monitoring engine 146 may monitor job acceptance, cancellation, arrival time, completion, customer feedback, provider rating, price change, route deviation, fraud signal, complaint, compliance failure, and payment status.

The learning and adaptation engine 148 may update threshold conditions, candidate ranking, search radius, invitation timing, incentive offers, compliance sequencing, and prediction models based on monitored outcomes.

The platform 100 may detect repeated coverage deficiencies in a region and initiate predictive pre-onboarding before a future service request is received. Predictive pre-onboarding may be based on historical demand, seasonality, time of day, weather, local events, geographic expansion patterns, customer abandonment, or known service gaps.

The platform 100 may therefore operate as a self-healing service network. Regions that repeatedly fail to satisfy demand automatically trigger additional provider acquisition, qualification, and activation until the deficiency is reduced or eliminated.

### Dynamic Radius Expansion

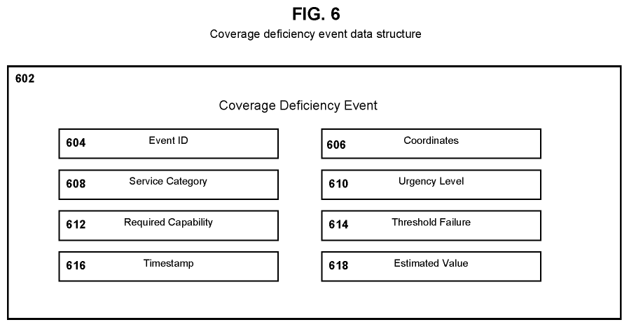

Referring to FIG. 6, the platform 100 may dynamically modify geographic search parameters. A first radius may be searched for active providers. If no eligible provider is found, a second radius may be searched. If the deficiency persists, the provider discovery engine 120 may search external provider sources 118 within an expanded region.

Radius expansion may depend on urgency, time elapsed, predicted travel time, service complexity, population density, road network conditions, historical provider density, maximum acceptable customer wait time, or predicted likelihood of provider acceptance.

The platform 100 may apply different expansion curves for different service categories. For example, an emergency lockout may expand quickly, while a scheduled commercial service may expand more slowly or may trigger predictive pre-onboarding instead of immediate dispatch.

### Incentive and Pricing Engine

The incentive engine 152 may determine whether to offer incentives to candidate providers. Incentives may include bonuses, surge pricing, preferred placement, fee discounts, reward points, digital tokens, future lead priority, or other economic benefits.

Incentive amounts may be calculated based on urgency, distance, scarcity, predicted acceptance probability, job value, customer wait time, provider history, or regional supply deficiency. Incentives may be transmitted within or alongside an invitation token 132.

In some embodiments, the incentive engine 152 modifies incentives dynamically while the Coverage Deficiency Event 112 remains unresolved. Incentives may increase as customer wait time increases or decrease when sufficient providers respond.

### Locksmith-Specific Embodiments

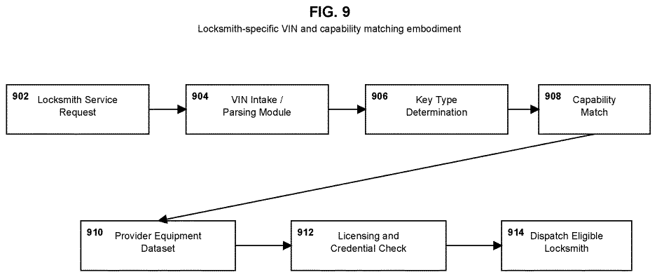

Referring to FIG. 9, in a locksmith-specific embodiment, the service request 104 may include a request for automotive lockout, lost key replacement, key duplication, residential lock service, commercial access service, safe service, electronic access service, or emergency lock service.

The compliance orchestration layer 126 may verify locksmith licensing, certifications, background-check status, business registration, insurance, bonding, association membership, government registration, or other trust signals depending on jurisdiction and service type.

For automotive locksmith requests, the VIN analysis module 154 may receive a vehicle identification number, license plate, year, make, model, trim, immobilizer system identifier, key code, or vehicle ownership information. The VIN analysis module 154 may determine a required key type, transponder requirement, programming requirement, blade type, fob type, immobilizer category, tool requirement, or dealer-code requirement.

The equipment capability database 156 may store provider equipment and capability data, including key machines, programmers, EEPROM tools, diagnostic devices, key blanks, remotes, transponder chips, European vehicle capability, luxury vehicle capability, motorcycle capability, safe tools, lock picking tools, and commercial access tools.

The job assignment engine 142 may assign a locksmith service request only to a provider node 140 having verified credentials and sufficient equipment capability. For example, a request involving Mercedes, BMW, Porsche, Bentley, Audi, or other specialized vehicles may require a provider profile indicating compatible equipment and verified capability before assignment.

The platform 100 may create a compliance audit trail for locksmith services because locksmith work involves physical access to homes, vehicles, businesses, safes, and secured areas. The audit trail may include identity verification, license check, customer authorization, service photos, geolocation, timestamps, invoice data, and provider certification status.

### Cross-Industry Embodiments

Although certain examples describe locksmith services, the invention is not limited to locksmith services. The same demand-triggered provider-generation architecture may be applied to roadside assistance, towing, jump starts, tire service, fuel delivery, appliance repair, HVAC repair, plumbing, electrical services, medical equipment repair, emergency facility access, commercial maintenance, property management services, utility services, field inspections, disaster response, and other service categories.

In each vertical, the service request 104 may define required capabilities, compliance rules, equipment requirements, urgency levels, and geographic constraints. The platform 100 may generate and activate provider nodes 140 in response to unmet demand within that vertical.

### Distributed and Multi-Region Operation

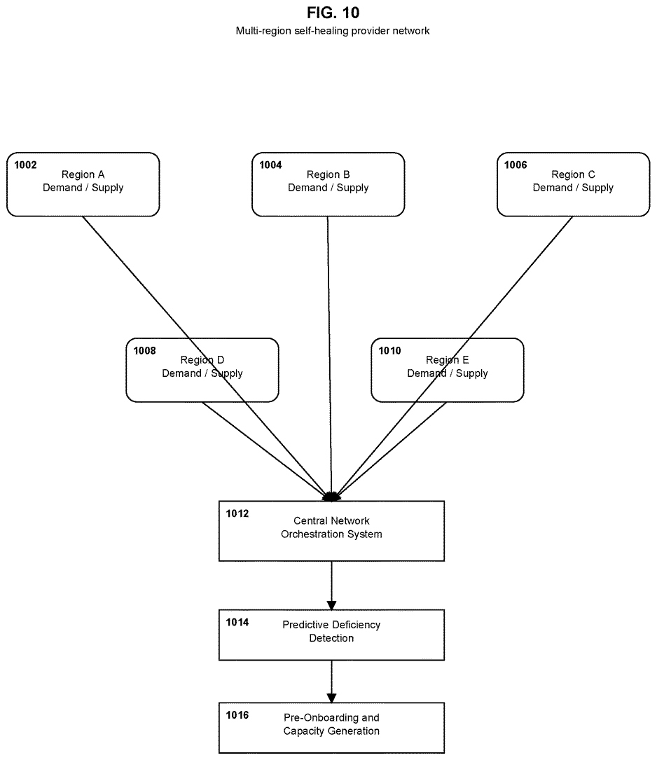

Referring to FIG. 10, a multi-region coordinator 158 may process Coverage Deficiency Events 112 from multiple cities, states, countries, service territories, or business units. The platform 100 may use multiple AI dispatch agents 116 operating concurrently.

The platform 100 may allocate computing resources based on event urgency, event volume, regional failure rates, service category, and predicted economic value. In some embodiments, event processing is distributed across cloud regions to reduce latency and improve resiliency.

The platform 100 may support tenant-specific rules for enterprises, insurers, roadside programs, dealerships, property managers, or government agencies. Each tenant may define service categories, compliance requirements, provider eligibility, pricing constraints, escalation rules, and data-sharing policies.

### Security, Privacy, and Auditability

The platform 100 may store sensitive data using encryption at rest and encryption in transit. Access controls may restrict viewing of identity documents, compliance results, customer addresses, vehicle identifiers, and payment data.

The audit log 150 may record system decisions in a tamper-evident manner. In some embodiments, audit entries may include cryptographic hashes, event identifiers, token identifiers, rule identifiers, model versions, source identifiers, and timestamps.

The platform 100 may preserve explainability data for provider ranking and assignment decisions. For example, the platform may store that a provider was selected because of verified license status, proximity, equipment compatibility, predicted arrival time, and highest completion probability.

### Alternative Embodiments

In one embodiment, the platform uses deterministic rule sets rather than machine learning models. In another embodiment, the platform uses machine learning models without large language models. In another embodiment, the platform uses an agentic architecture in which an AI dispatch agent calls external tools, APIs, and verification services.

In one embodiment, onboarding is completed before any job is assigned. In another embodiment, a provider may reserve or conditionally accept the job during onboarding, and final assignment occurs only after completion of required verification steps.

In one embodiment, candidate providers are invited one at a time. In another embodiment, candidate providers are invited in batches. In another embodiment, providers compete based on response time, price, capability, compliance, customer rating, or predicted completion probability.

In one embodiment, the platform creates provider accounts only after full verification. In another embodiment, the platform creates a limited provider account and activates additional capabilities as compliance steps are completed.

In one embodiment, the platform is configured for emergency services. In another embodiment, the platform is configured for scheduled services. In another embodiment, the platform supports both emergency and scheduled services with different trigger thresholds and onboarding workflows.

In one embodiment, the platform uses the Coverage Deficiency Event 112 only after a failed provider search. In another embodiment, the platform predicts deficiencies before a service request is received and initiates pre-onboarding to prevent future failures.

The described embodiments are illustrative and may be combined, separated, reordered, modified, or omitted without departing from the scope of the invention as claimed.

What is claimed is:

1. A computer-implemented system for autonomous demand-triggered generation and deployment of service providers, the system comprising: one or more processors; and one or more non-transitory computer-readable media storing instructions that, when executed by the one or more processors, cause the system to: receive, from a user device, a service request comprising a geographic location and a service category; query a provider availability dataset to identify eligible registered providers for the service request; determine that a coverage deficiency exists based on at least one threshold condition associated with provider availability; generate a machine-readable coverage deficiency event in response to the coverage deficiency; in response to the coverage deficiency event, identify at least one candidate service provider that is not active in the provider availability dataset; initiate an onboarding workflow for the candidate service provider; perform at least one automated qualification check on onboarding data received from the candidate service provider; activate a provider node corresponding to the candidate service provider after satisfaction of activation criteria; assign the service request to the activated provider node; and update system state data based on an outcome of the service request.

2. The system of claim 1, wherein the at least one threshold condition comprises at least one of a minimum provider count within a geographic region, a maximum estimated response time, a minimum predicted acceptance probability, a minimum trust score, a maximum customer wait time, a service-specific compliance requirement, or a minimum equipment capability score.

3. The system of claim 1, wherein the coverage deficiency event comprises at least one of a location identifier, service category, urgency level, required credential, required equipment capability, expiration time, customer wait threshold, expected value, incentive budget, or compliance requirement.

4. The system of claim 1, wherein the coverage deficiency event is published to an event bus, queue, event stream, message broker, webhook endpoint, serverless function, microservice bus, or distributed workflow engine for processing by an artificial intelligence dispatch agent.

5. The system of claim 1, wherein identifying the at least one candidate service provider comprises accessing one or more external data sources and generating a candidate provider profile comprising contact information, service category information, geographic service area information, credential information, equipment indicators, or prior contact history.

6. The system of claim 1, wherein the instructions further cause the system to rank a plurality of candidate service providers using a classification model based on predicted capability, proximity, availability, response probability, credential status, equipment capability, trust signal, price estimate, or predicted completion probability.

7. The system of claim 1, wherein the automated qualification check comprises identity verification, credential verification, license verification, insurance verification, bonding verification, business registration verification, equipment attestation, sanctions screening, fraud risk scoring, background check initiation, or jurisdiction-specific compliance verification.

8. The system of claim 1, wherein the onboarding workflow comprises generating a secure invitation token that is cryptographically signed, time-limited, single-use, bound to the service request, bound to the candidate service provider, bound to a geographic region, or bound to a compliance workflow.

9. The system of claim 8, wherein the secure invitation token is transmitted by SMS, email, push notification, automated voice call, messaging platform, web portal link, or API call after enforcement of a do-not-contact rule, opt-out rule, communication frequency limit, channel preference, or consent-status rule.

10. The system of claim 1, wherein assigning the service request comprises calculating an assignment score based on proximity, estimated travel time, readiness, credential status, equipment capability, price, incentive cost, customer rating, jurisdictional compliance, service type, or predicted completion probability.

11. The system of claim 1, wherein the service request triggers identifying the candidate service provider, initiating the onboarding workflow, activating the provider node, and assigning the service request within a single execution cycle without human dispatcher intervention.

12. The system of claim 1, wherein the instructions further cause the system to update a learning and adaptation engine based on completion status, response time, provider rating, cancellation, compliance failure, fraud signal, price acceptance, travel time, customer feedback, or regional demand pattern.

13. The system of claim 1, wherein the instructions further cause the system to dynamically expand a geographic search radius based on elapsed time, urgency, service type, predicted travel time, regional density, customer wait threshold, historical fulfillment data, or probability of fulfillment.

14. A computer-implemented method for autonomous expansion of a service provider network, the method comprising: receiving a service request associated with a location and a service type; determining, by one or more processors, that registered provider supply is insufficient to fulfill the service request; generating a machine-readable coverage deficiency event; identifying, in response to the coverage deficiency event, an external candidate service provider that is not an active registered provider; transmitting an onboarding invitation to the external candidate service provider; receiving onboarding data from the external candidate service provider; verifying at least a portion of the onboarding data using an automated verification process; creating a provider account for the external candidate service provider; activating the provider account as an available provider node; and assigning the service request to the available provider node.

15. The method of claim 14, wherein determining that registered provider supply is insufficient comprises determining that no eligible provider exists within a first geographic radius and dynamically expanding the first geographic radius to a second geographic radius based on elapsed time, urgency, service type, population density, historical fulfillment data, or predicted travel time.

16. The method of claim 14, further comprising ranking a plurality of external candidate service providers and transmitting onboarding invitations to at least two of the plurality of external candidate service providers, wherein assigning the service request comprises assigning the service request to a first candidate service provider that completes a required onboarding step or to a highest-ranked candidate service provider satisfying activation criteria.

17. The method of claim 14, further comprising generating an audit log identifying a data source used to identify the external candidate service provider, a compliance rule applied to the external candidate service provider, a secure invitation token, and an assignment decision.

18. A distributed service network control system comprising: a request intake engine configured to receive service requests from user devices; a coverage evaluation engine configured to determine whether registered provider supply satisfies threshold conditions for the service requests; an event processing layer configured to generate coverage deficiency events when the threshold conditions are not satisfied; an autonomous provider discovery engine configured to identify external providers responsive to the coverage deficiency events; a compliance orchestration layer configured to verify external providers according to service-category and jurisdiction-specific rules; an onboarding subsystem configured to activate verified external providers as provider nodes; an assignment engine configured to assign originating service requests to the provider nodes activated in response to the originating service requests; and a learning and adaptation engine configured to modify future threshold conditions, provider rankings, invitation timing, search radii, compliance sequencing, or incentive amounts based on service outcomes.

19. The distributed service network control system of claim 18, wherein the service category comprises locksmith services and the compliance orchestration layer verifies locksmith licensing, certification, insurance, bonding, business registration, or equipment capability.

20. The distributed service network control system of claim 19, further comprising a vehicle identification number analysis module configured to determine a required key type, transponder requirement, programming requirement, blade type, fob type, immobilizer category, or tool requirement, wherein the assignment engine assigns a locksmith service request based at least in part on matching the required key type or tool requirement to equipment capability data associated with a provider node.
